(19) United States
(12) Patent Application Publication
(10) Pub. No.: US 2025/0218399 A1
(43) Pub. Date: Jul. 3, 2025

(54) DISPLAY DEVICE AND DRIVING METHOD

(71) Applicant: LG Display Co., Ltd., Seoul (KR)

(72) Inventors: Donggun LEE, Paju-si (KR); Boyun JUNG, Paju-si (KR)

(21) Appl. No.: 18/976,966

(22) Filed: Dec. 11, 2024

(30) Foreign Application Priority Data
Dec. 28, 2023 (KR) 10-2023-0194626

(51) Int. Cl. G09G 3/3275

(52) U.S. Cl. CPC G09G 3/3275; G09G 2310/0297; G09G 2320/0233; G09G 2330/021; G09G 2330/028

(57) ABSTRACT

Embodiments of the present disclosure relate to relate to a display device and a driving method of a display device. More specifically, a gamma voltage compensation circuit for supplying the high reference voltage and the low reference voltage to a reference gamma generating circuit may be electrically connected to a display panel through a first voltage line and a second voltage line, thereby compensating a voltage drop phenomenon of a driving voltage VDD.

### CROSS REFERENCE TO RELATED APPLICATION

This application claims priority from Korean Patent Application No. 10-2023-0194626, filed on Dec. 28, 2023, which is hereby incorporated by reference for all purposes as if fully set forth herein.

### BACKGROUND

### Technical Field

Embodiments of the present disclosure relate to a power management circuit, a display device and a driving method of a display device.

### Description of the Related Art

As the information society develops, there is increasing the demand for display devices for displaying images in various forms. Therefore, in recent years, there have been used various display devices such as liquid crystal displays and organic light emitting display devices.

In order to drive the display device, the display device may supply voltage to a display panel, a data driving circuit, a gate driving circuit, and a controller.

A driving voltage may be supplied to the display panel. There may be occurred a voltage drop of the driving voltage, which may cause luminance non-uniformity in a display panel.

### BRIEF SUMMARY

Embodiments of the present disclosure may provide a display device capable of compensating for a voltage drop phenomenon in the driving voltage, and a driving method of a display device.

Embodiments of the present disclosure may provide a display device capable of equalizing the luminance of a display panel, and a driving method of a display device.

Embodiments of the present disclosure may provide a display device capable of low power consumption by equalizing the luminance of a display panel, and a driving method of a display device.

Embodiments of the present disclosure may provide a display device including a data driving circuit configured to be supplied with a plurality of gamma voltages, a gamma voltage generating circuit configured to supply the plurality of gamma voltages to the data driving circuit, a reference gamma voltage generating circuit configured to generate a plurality of reference gamma voltages based on a high reference voltage and a low reference voltage and supply the plurality of reference gamma voltages to the gamma voltage generating circuit, and a gamma voltage compensation circuit configured to supply the high reference voltage and the low reference voltage to the reference gamma generating circuit, wherein the gamma voltage compensation circuit is electrically connected to a display panel through a first voltage line and a second voltage line.

Embodiments of the present disclosure may provide a driving method of a display device including supplying, by a gamma voltage compensation circuit, a high reference voltage and a low reference voltage to a reference gamma voltage generating circuit, generating and supplying a plurality of reference gamma voltages based on the high reference voltage and the low reference voltage to a gamma voltage generating circuit, and supplying a plurality of gamma voltages to a data driving circuit based on the plurality of reference gamma voltages, wherein the gamma voltage compensation circuit is electrically connected to a display panel through a first voltage line and a second voltage line.

Embodiments of the present disclosure may provide a display device and a driving method thereof capable of compensating for a voltage drop phenomenon in the driving voltage VDD.

Embodiments of the present disclosure may provide a display device and a driving method thereof capable of equalizing the luminance of a display panel 110.

Embodiments of the present disclosure may provide a display device and a driving method thereof capable of low power consumption by equalizing the luminance of a display panel 110.

### BRIEF DESCRIPTION OF THE SEVERAL VIEWS OF THE DRAWINGS

FIG. 1 illustrates a schematic configuration of a display device according to embodiments of the present disclosure.

FIG. 2 illustrates a data driving circuit according to embodiments of the present disclosure.

FIG. 3 illustrates a voltage drop phenomenon and a feedback of the driving voltage generated in a display panel according to embodiments of the present disclosure.

FIG. 4 is a diagram for explaining the on-pixel ratio according to embodiments of the present disclosure.

FIGS. 5 and 6 are diagrams for explaining a method of compensating for a voltage drop phenomenon in the driving voltage according to embodiments of the present disclosure.

FIG. 7 illustrates a gamma voltage compensation circuit 700 according to embodiments of the present disclosure.

FIG. 8 illustrates a scan signal supply direction and a 10-bits signal according to embodiments of the present disclosure.

FIG. 9 illustrates a relative bit ratio according to a position of a display panel according to embodiments of the present disclosure.

FIGS. 10 to 13 illustrate an example of an operation of a gamma voltage compensation circuit according to embodiments of the present disclosure.

FIGS. 14 to 20 illustrate voltage lines disposed on a display panel according to embodiments of the present disclosure.

FIGS. 21 and 22 illustrate a reference voltage conversion circuit according to embodiments of the present disclosure.

FIGS. 23 and 24 are graphs of voltage according to an operation of a feedback driving voltage generating circuit and the reference voltage conversion circuit according to embodiments of the present disclosure.

FIG. 25 is a flowchart of a driving method of a display device according to embodiments of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including,” “having,” “containing,” “constituting” “make up of,” and “formed of” used herein are generally intended to allow other components to be added unless the terms are used with the term “only.” As used herein, singular forms are intended to include plural forms unless the context clearly indicates otherwise.

Terms, such as “first,” “second,” “A,” “B,” “(A),” or “(B)” may be used herein to describe elements of the present disclosure. Each of these terms is not used to define essence, order, sequence, or number of elements, etc., but is used merely to distinguish the corresponding element from other elements.

When it is mentioned that a first element “is connected or coupled to,” “contacts or overlaps,” etc., a second element, it should be interpreted that, not only can the first element “be directly connected or coupled to” or “directly contact or overlap” the second element, but a third element can also be “interposed” between the first and second elements, or the first and second elements can “be connected or coupled to,” “contact or overlap,” etc., each other via a fourth element. Here, the second element may be included in at least one of two or more elements that “are connected or coupled to,” “contact or overlap,” etc., each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes, etc., are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can.”

Hereinafter, various embodiments of the disclosure are described in detail with reference to the accompanying drawings.

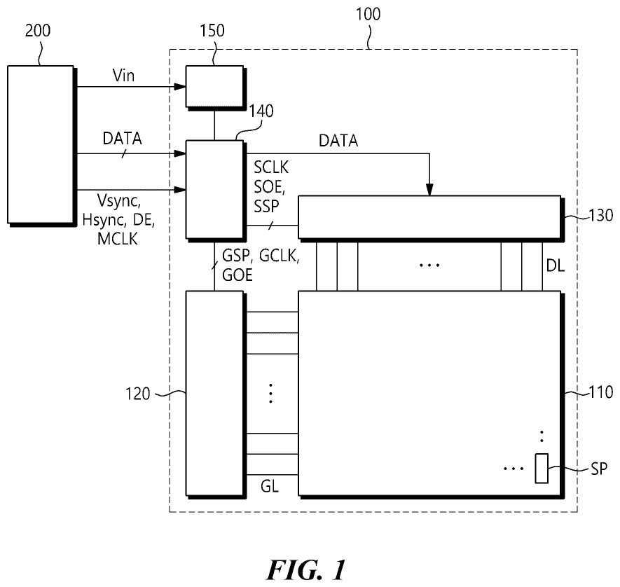

FIG. 1 illustrates a schematic configuration of a display device 100 according to embodiments of the present disclosure.

Referring to FIG. 1, a display device 100 according to embodiments of the present disclosure may include a display panel 110 in which a plurality of gate lines GL and data lines DL are disposed and a plurality of subpixels SP are arranged in a matrix form, a gate driving circuit 120 for driving the plurality of gate lines GL, a data driving circuit 130 for supplying data voltage through the plurality of data lines DL, a controller 140 for controlling the data driving circuit 120 and the data driving circuit 130, and a power management circuit 150.

The display panel 110 may display the image based on a scan signal transmitted from the gate driving circuit 120 through a plurality of gate lines GL and a data voltage transmitted from the data driving circuit 130 through a plurality of data lines DL.

In the case of an organic light emitting display, the display panel 110 may be implemented as a top emission method, a bottom emission method, or a dual emission method.

The display panel 110 may include a plurality of pixels arranged in a matrix form, and each pixel may include subpixels SP of different colors, for example, a white subpixel, a red subpixel, a green subpixel, and a blue subpixel. In addition, each subpixel SP may be defined by a plurality of data lines DL and a plurality of gate lines GL.

One subpixel SP may include a thin film transistor TFT formed in the area where one data line DL and one gate line GL intersect, a light emitting device such as an organic light emitting diode which charges the data voltage, and a storage capacitor electrically connected to the light emitting device to maintain a voltage.

For example, in the case that a display device 100 with a resolution of 2160×3840 includes four subpixels of white (W), red (R), green (G), and blue (B), there may be provided 2,160 gate lines GL and a total of 3,840×4=15,360 data lines DL by and 3,840 data lines DL each connected to 4 subpixels (WRGB). A subpixel SP may be disposed at each point where the gate line GL and the data line DL intersect.

The gate driving circuit 120 may be controlled by the controller 140, and sequentially output scan signals to a plurality of gate lines GL arranged on the display panel 110 to control the driving timing for a plurality of subpixels SP.

In this case, the gate driving circuit 120 may include one or more gate driving integrated circuits GDIC, and may be located only on one side of the display panel 110 or may be located on both sides of the display panel 110 depending on the driving method. Alternatively, the gate driving circuit 120 may be embedded in a bezel area of the display panel 110 to be implemented in a gate-in-panel (GIP) type.

The data driving circuit 130 may receive image data DATA from the controller 140, and convert the received image data DATA into an analog data voltage. Then, the data driving circuit 130 may output a data voltage to each data line DL in accordance with the timing of applying the scan signal through the gate line GL, so that each subpixel SP connected to the data line DL may display a light with brightness corresponding to the data voltage.

Similarly, the data driving circuit 130 may include one or more source driving integrated circuits SDICs, and the source driving integrated circuit SDIC may be connected to a bonding pad of the display panel 110 using a tape automated bonding (TAB) method or a chip-on-glass (COG) method, or may be disposed directly on the display panel 110.

Depending on the case, each source driving integrated circuit SDIC may be integrated and disposed on the display panel 110. In addition, each source driving integrated circuit SDIC may be implemented in a chip-on-film (COF) method. In this case, each source driving integrated circuit SDIC may be mounted on a circuit film, and may be electrically connected to the data line DL of the display panel 110 through a circuit film.

The controller 140 may supply various control signals to the gate driving circuit 120 and the data driving circuit 130, and control the operations of the gate driving circuit 120 and the data driving circuit 130. That is, the controller 140 may control the gate driving circuit 120 to output a scan signal according to the timing implemented in each frame, and may transmit image data DATA received from the outside to the data driving circuit 130.

In this case, the controller 140 may receive image data DATA and various timing signals, including a vertical synchronization signal Vsync, a horizontal synchronization signal Hsync, a data enable DE signal, and a main clock MCLK from the external host system 200.

The host system 200 may be any one of a television system, a set-top box, a navigation system, a personal computer (PC), a home theater system, a mobile device, and a wearable device.

Accordingly, the controller 140 may generate a control signal using various timing signals received from the host system 200, and transmit the timing signal to the gate driving circuit 120 and the data driving circuit 130.

For example, in order to control the gate driving circuit 120, the controller 140 may output various gate control signals, including a gate start pulse signal GSP, a gate clock GCLK, and a gate output enable signal GOE. Here, the gate start pulse GSP may control the operation start timing of one or more gate driving integrated circuits GDIC constituting the gate driving circuit 120. Additionally, the gate clock GCLK is a clock signal commonly input to one or more gate driving integrated circuits GDIC, and may control the shift timing of the scan signal. Additionally, the gate output enable signal GOE may specify timing information of one or more gate driver integrated circuits GDIC.

In addition, in order to control the data driving circuit 130, the controller 140 may output various data control signals such as a source start pulse SSP, a source sampling clock SCLK, and a source output enable signal SOE. Here, the source start pulse SSP may control the timing at which one or more source driving integrated circuits SDICs constituting the data driving circuit 130 start sampling data. The source sampling clock SCLK is a clock signal which controls the timing of sampling data in a source driving integrated circuit SDIC. The source output enable signal SOE may control the output timing of the data driving circuit 130.

The display device 100 may include a power management circuit 150 which supplies various voltages or currents to the display panel 110, the gate driving circuit 120, and the data driving circuit 130, or controls the various voltages or currents to be supplied.

The power management circuit 150 may adjust the direct current input voltage Vin supplied from the host system 200 to generate the power to drive the display panel 100, the gate driving circuit 120, and the data driving circuit 130. The power management circuit 150 may be referred to as a power management integrated circuit (PMIC). The power management circuit 150 may generate voltages such as a driving voltage VDD, a base voltage VSS, a gate high voltage VGH, a gate low voltage VGL, a source driving voltage SVDD, and a reference voltage Vref.

Meanwhile, the subpixel SP may be located at a point where the gate line GL and the data line DL intersect, and a light emitting device may be disposed in each subpixel SP. For example, an organic light emitting display device may include a light emitting device such as an organic light emitting diode in each subpixel SP, and may display an image by controlling the current flowing through the light emitting device according to the data voltage.

The display device 100 may be of various types such as a liquid crystal display, organic light emitting display, and plasma display panel.

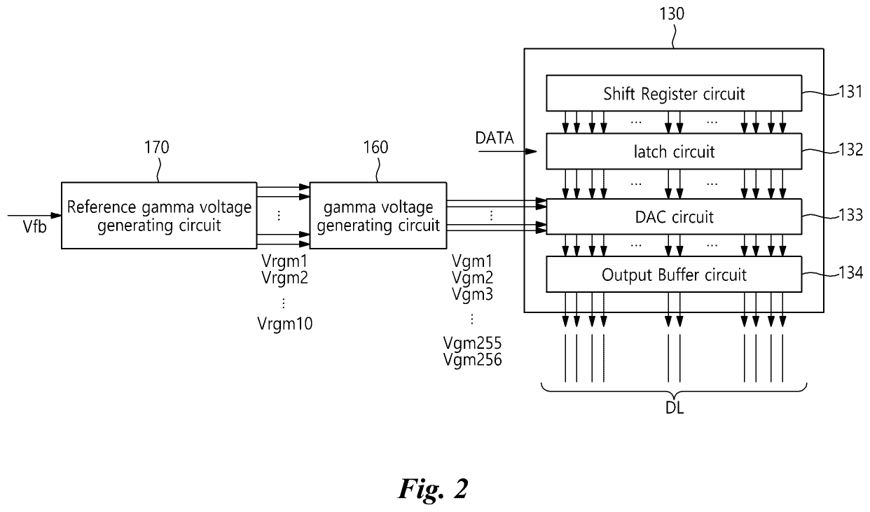

FIG. 2 illustrates a data driving circuit 130 according to embodiments of the present disclosure.

Referring to FIG. 2, the data driving circuit 130 may include a shift register circuit 131, a latch circuit 132, a digital-to-analog conversion circuit 133, and an output buffer circuit 134.

The shift register circuit 131 may sequentially output latch pulses to a plurality of latches included in the latch circuit 132. The shift register circuit 131 may include a plurality of shift registers.

The latch circuit 132 may sequentially store image data DATA in response to the latch pulse. The latch circuit 132 may include a plurality of latches.

The digital-to-analog conversion circuit 133 may convert the image data DATA output from the latch circuit 132 into an initial data voltage, which is an analog voltage. The digital-to-analog conversion circuit 133 may include a plurality of digital-to-analog converters.

The output buffer circuit 134 may receive and amplify the initial data voltage from the digital-to-analog conversion circuit 133 to generate a data voltage. Thereafter, the output buffer circuit 134 may output data voltages to a plurality of data lines DL disposed on the display panel 110. The output buffer circuit 134 may include a plurality of output buffers.

Referring to FIG. 2, a gamma voltage generating circuit 160 may output a gamma voltage Vgm to the digital-to-analog conversion circuit 133. The digital-to-analog conversion circuit 133 may select the gamma voltage Vgm corresponding to the image data DATA as the data voltage and output the gamma voltage Vgm to the output buffer circuit 134.

A reference gamma voltage generating circuit 170 may generate a reference gamma voltage Vrgm and output the reference gamma voltage Vrgm to the gamma voltage generating circuit 160. The gamma voltage generating circuit 160 may generate a gamma voltage Vgm based on the reference gamma voltage Vrgm. The number of reference gamma voltages Vrgm may be less than the number of gamma voltages Vgm. For example, the reference gamma voltage Vrgm may include a first reference gamma voltage Vrgm1, a second reference gamma voltage Vrgm2 to a tenth reference gamma voltage Vrgm10. The gamma voltage Vgm generated based on the reference gamma voltage Vrgm may include a first gamma voltage Vgm1, a second gamma voltage Vgm2 to a 256-th gamma voltage Vgm256. This is an example, and the number of reference gamma voltages Vrgm and gamma voltages Vgm may vary depending on the design.

The gamma voltage generating circuit 160 and the reference gamma voltage generating circuit 170 may be supplied with two or more voltages. The gamma voltage generating circuit 160 and the reference gamma voltage generating circuit 170 may divide two or more voltages through a voltage string. The gamma voltage generating circuit 160 and the reference gamma voltage generating circuit 170 may select and output one voltage among the divided voltages. In order to select and output one of the divided voltages, the gamma voltage generating circuit 160 and the reference gamma voltage generating circuit 170 may include a Mux-circuit or a plurality of switches. The gamma voltage generating circuit 160 and the reference gamma voltage generating circuit 170 may select a voltage to be output through a Mux-circuit or a plurality of switches.

Meanwhile, the reference gamma voltage generating circuit 170 may be supplied with a feedback driving voltage Vfb fed back through a feedback line electrically connected to the display panel 110. Hereinafter, it will be described the feedback driving voltage Vfb in detail.

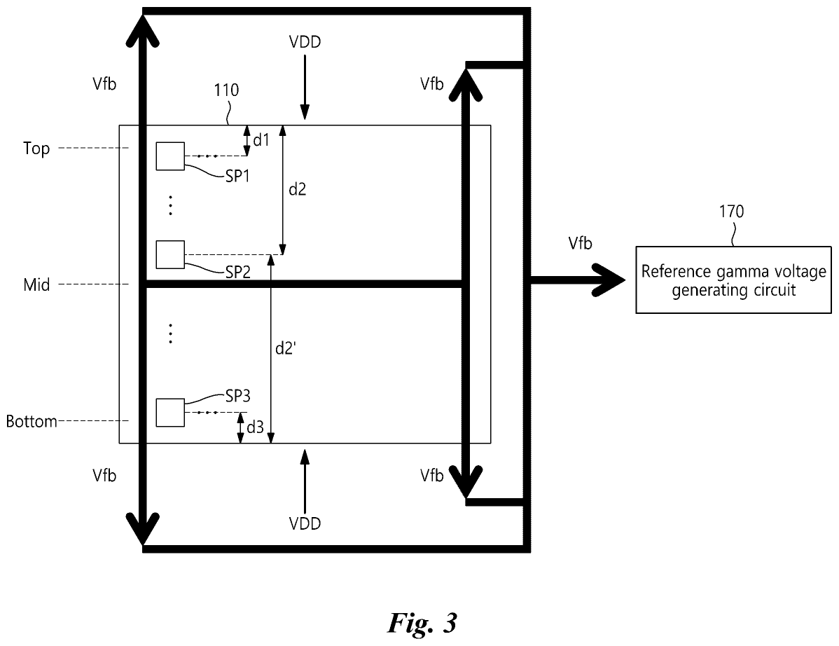

FIG. 3 illustrates a voltage drop phenomenon and a feedback of the driving voltage generated in a display panel 110 according to embodiments of the present disclosure.

Referring to FIG. 3, a plurality of subpixels SP may be disposed on the display panel 110.

Referring to FIG. 3, the display panel 110 may be divided into a top area Top, a middle area Mid, and a bottom area Bottom based on ae vertical direction.

A first subpixel SP1 may be disposed in the top area Top.

A second subpixel SP2 may be disposed in the middle area Mid.

A third subpixel SP3 may be disposed in the bottom area Bottom.

Referring to FIG. 3, a plurality of subpixels SP may be supplied with a driving voltage VDD. The driving voltage VDD may be supplied from both sides or one side of the display panel 110, and will be described below assuming that it is supplied from both sides of the display panel 110.

The method in which the driving voltage VDD is supplied from both sides of the display panel 110 may be referred to as a “double feeding method.” Alternatively, the method in which the driving voltage VDD is supplied from one side of the display panel 110 may be referred to as a “single feeding method.” Embodiments of the present disclosure may be applicable to both the double feeding method and the single feeding method, but it will be described the single feeding method as an example, for convenience of explanation.

If the driving voltage VDD is supplied to a plurality of subpixels SP, there may be occurred a voltage drop phenomenon in the driving voltage VDD.

Referring to FIG. 3, a distance d2 at which the driving voltage VDD is supplied to the second subpixel SP2 may be greater than a distance d1 at which the driving voltage VDD is supplied to the first subpixel SP1. Accordingly, a level of the driving voltage VDD supplied to the second subpixel SP2 may be different from a level of the driving voltage VDD supplied to the first subpixel SP1.

Referring to FIG. 3, assuming that the second subpixel SP2 receives the driving voltage VDD from the bottom of the display panel 110, a distance d2′ over which the driving voltage VDD is supplied to the second subpixel SP2 may be longer than a distance d3 over which the driving voltage VDD is supplied to the third subpixel SP3. Accordingly, a level of the driving voltage VDD supplied to the second subpixel SP2 may be different from a level of the driving voltage VDD supplied to the third subpixel SP3.

Referring to FIG. 3, in order to compensate for the voltage drop phenomenon occurring in the driving voltage VDD supplied to the middle area Mid, the reference gamma voltage generating circuit 170 may receive feedback of the driving voltage VDD supplied to the subpixel SP disposed in the middle area Mid. A feedback driving voltage Vfb fed back from the middle area Mid of the display panel 110 may be supplied to the reference gamma voltage generating circuit 170.

Hereinafter, it will be described a method of compensating for the voltage drop occurring in the driving voltage VDD using the feedback driving voltage Vfb.

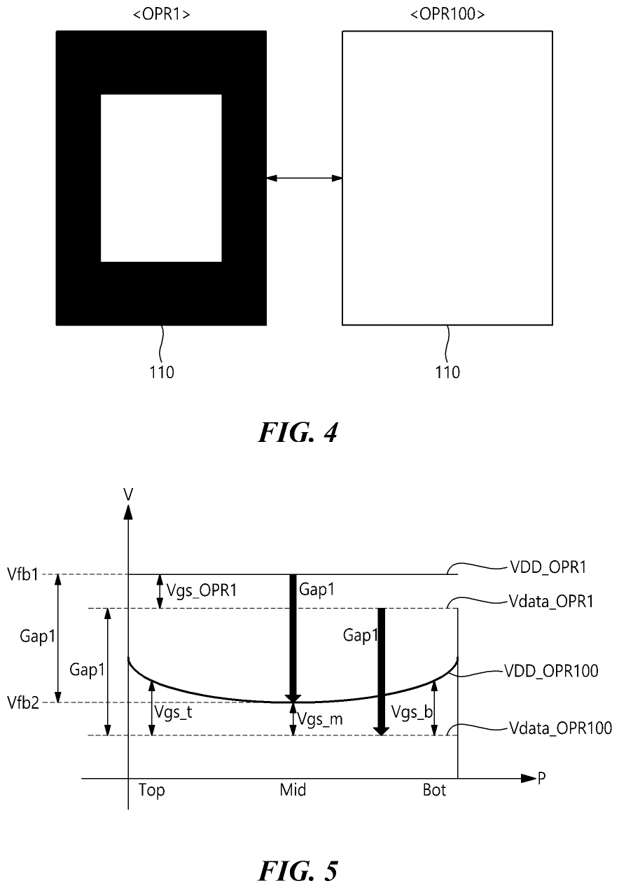

FIG. 4 is a diagram for explaining the on-pixel ratio according to embodiments of the present disclosure.

The “on pixel ratio (OPR)” may be defined to explain a manner of compensating for the voltage drop occurring in the driving voltage VDD.

Referring to FIG. 4, “1% on-pixel ratio OPR1” may be a lighting ratio when only some subpixels among a plurality of subpixels emit light. In the case that the display is driven at 1% on-pixel ratio OPR1, the display panel 110 may express a low grayscale close to black. The 100% on-pixel ratio OPR100 may be the lighting ratio when most of the subpixels among the plurality of subpixels emit light. In case of driving at 100% on-pixel ratio OPR100, the display panel 110 may express a high grayscale close to white.

If the display panel 110 is driven at the 1% on-pixel ratio OPR1, the drop in the driving voltage VDD may occur relatively weakly since only some subpixels are driven. On the other hand, when the display panel 110 is driven at the 100% on-pixel ratio OPR100, there may be occurred a relatively strong drop in the driving voltage VDD due to the driving of most subpixels.

Hereinafter, the driving the display panel 110 at the 1% on-pixel ratio OPR1 may be expressed as an “OPR1 driving,” and the driving the display panel 110 at 100% on-pixel ratio OPR100 may be expressed as an “OPR100 driving.”

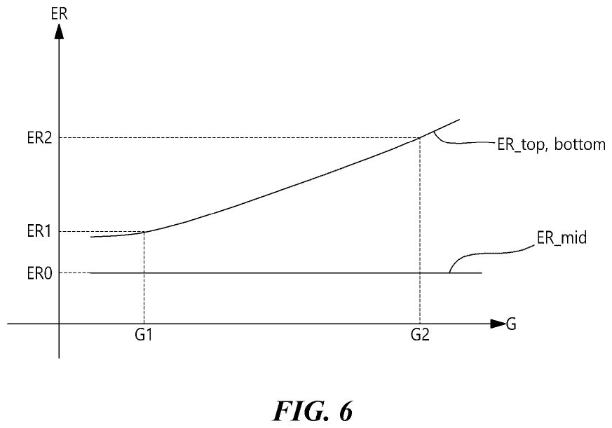

FIGS. 5 and 6 are diagrams for explaining a method of compensating for a voltage drop phenomenon in the driving voltage according to embodiments of the present disclosure.

Referring to FIG. 5, there is illustrated a graph of voltage V according to the position P of the display panel.

Referring to FIG. 5, the voltage level of the driving voltage distribution VDD_OPR1 of the display panel 110 in case of the OPR1 driving may be maintained at a level of a first feedback driving voltage Vfb1. That is, in case of the OPR1 driving, the driving voltage distribution VDD_OPR1 of the display panel 110 may be uniform over the entire area of the display panel 110. In addition, referring to FIG. 5, the data voltage distribution Vdata_OPR1 in case of the OPR1 driving may be a uniform voltage distribution like the driving voltage distribution VDD_OPR1 of the display panel 110 in the OPR1 driving.

Referring to FIG. 5, the driving voltage distribution VDD_OPR100 of the display panel 110 in case of the OPR100 driving may represent “U” shaped voltage curve. The driving voltage of the middle area Mid of the display panel 110 may be a second feedback driving voltage Vfb2. As moving from the middle area Mid to the top area Top of the display panel 110, the driving voltage distribution VDD_OPR100 may become larger than the second feedback voltage Vfb2. Additionally, as moving from the middle area Mid to the bottom area Bottom of the display panel 110, the driving voltage distribution VDD_OPR100 may become larger than the second feedback voltage Vfb2.

That is, there may be occurred a voltage drop in the driving voltage in the OPR100 driving. In order to solve the above-described problem, the second feedback driving voltage Vfb2 fed back from the middle area Mid of the display panel 110 may be supplied to the reference gamma voltage generating circuit 170. After the second feedback driving voltage Vfb2 is fed back, there may be calculated a first difference voltage Gap1, which is a difference voltage between the second feedback driving voltage Vfb2 and the first feedback driving voltage Vfb1.

The data voltage distribution Vdata_OPR100 in the OPR100 driving may be generated by subtracting the first difference voltage Gap1 from the data voltage distribution Vdata_OPR1 in the OPR1 driving. However, in this case, the driving voltage drop in the middle area Mid may be compensated, but the driving voltage drop in other areas may not be compensated.

Referring to FIG. 5, a gate-source voltage Vgs_t of the top area Top may be greater than a gate-source voltage Vgs_m of the middle area Mid. In addition, a gate-source voltage Vgs_b of the bottom area Bot may be greater than a gate-source voltage Vgs_m of the middle area Mid. Since the gate-source voltage Vgs_t of the top area and the gate-source voltage Vgs_b of the bottom area are greater than a target gate-source voltage, there may be occurred an over-compensation in the case of the corresponding areas Top and Bot. Since the over-compensation occurs in the case of the corresponding areas Top and Bot compared to the middle area Mid, the luminance of the corresponding area Top and Bot may become brighter and the image quality characteristics of the display panel 110 may deteriorate.

That is, there may be a problem in which a luminance difference occurs between OPR1 driving and OPR100 driving due to a voltage drop phenomenon in the driving voltage. Therefore, an error rate ER may be calculated based on the 1% on-pixel ratio OPR1 and 100% on-pixel ratio OPR100.

Referring to FIG. 6, there is illustrated an error rate ER graph according to grayscale G.

In all grayscales G, the error rate ER_mid of the middle area Mid may be lower than the error rate ER_top, bottom of the remaining areas Top and Bot. Referring to FIG. 6, the error rate ER_top, bottom of the remaining area Top and Bot may increase from low grayscale G1 to high grayscale G2. This phenomenon occurs since the driving voltage VDD is compensated based only on the feedback driving voltage Vfb fed back from the middle area Mid. Accordingly, there may occur a luminance non-uniformity problem in the display panel 110.

That is, as the amount of current flowing through the display panel 110 increases, the voltage drop phenomenon in the driving voltage VDD may become stronger. Due to a voltage drop phenomenon in the driving voltage VDD, the driving voltage VDD supplied to the subpixel SP may be lowered. Accordingly, the luminance may further decrease at the 100% on-pixel ratio OPR100 compared to the 1% on-pixel ratio OPR1.

Accordingly, embodiments of the present disclosure may provide a display device capable of compensating for a voltage drop in the driving voltage VDD, and a method of driving the display device.

Embodiments of the present disclosure may provide a display device capable of uniformizing the luminance of the display panel 110, and a method of driving the display device.

Embodiments of the present disclosure may provide a display device capable of low power consumption by uniformizing the luminance of the display panel 110, and a method of driving the display device. This will be explained in detail below.

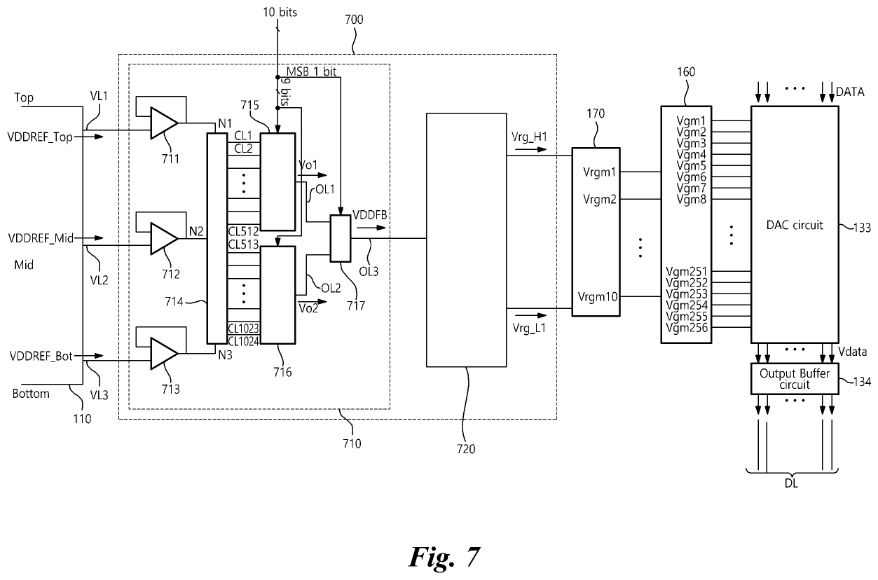

FIG. 7 illustrates a gamma voltage compensation circuit 700 according to embodiments of the present disclosure.

The gamma voltage compensation circuit 700 may include a feedback driving voltage generating circuit 710 and a reference voltage conversion circuit 720.

The feedback driving voltage generating circuit 710 may supply a feedback driving voltage VDDFB based on a top reference driving voltage VDDREF_Top, a middle reference driving voltage VDDREF_Mid, and a bottom reference driving voltage VDDREF_Bot.

The feedback driving voltage generating circuit 710 may be electrically connected to a first voltage line VL1. The feedback driving voltage generating circuit 710 may receive the top reference driving voltage VDDREF_Top through the first voltage line VL1. The top reference driving voltage VDDREF_Top may be a first reference driving voltage.

The feedback driving voltage generating circuit 710 may be electrically connected to a second voltage line VL2. The feedback driving voltage generating circuit 710 may receive a middle reference driving voltage VDDREF_Mid through the second voltage line VL2. The middle reference driving voltage VDDREF_Mid may be a second reference driving voltage.

The feedback driving voltage generating circuit 710 may be electrically connected to a third voltage line VL3. The feedback driving voltage generating circuit 710 may receive a bottom reference driving voltage VDDREF_Bot through the third voltage line VL3. The bottom reference driving voltage VDDREF_Bot may be a third reference driving voltage.

The feedback driving voltage generating circuit 710 may output a feedback driving voltage VDDFB based on the top reference driving voltage VDDREF_Top and the middle reference driving voltage VDDREF_Mi. In addition, the feedback driving voltage generating circuit 710 may output a feedback driving voltage VDDFB based on the bottom reference driving voltage VDDREF_Bot and the middle reference driving voltage VDDREF_Mid.

The feedback driving voltage generating circuit 710 may include a first buffer 711, a second buffer 712, a third buffer 713, a resistor string 714, a first multiplexer 715, and a second multiplexer 716, and a third multiplexer 717.

Each of the first buffer 711, the second buffer 712, and the third buffer 713 may include an operational amplifier. Each of the first buffer 711, the second buffer 712, and the third buffer 713 may be configured as a circuit which functions as a buffer. That is, each of the first buffer 711, the second buffer 712, and the third buffer 713 may supply an input voltage supplied to an input terminal as an output voltage to an output terminal.

The first buffer 711 may receive the top reference driving voltage VDDREF_Top from a first input node through a first voltage line VL1. A second input node of the first buffer 711 may be electrically connected to an output node of the first buffer 711. The first buffer 711 may supply the top reference driving voltage VDDREF_Top to a first node N1, which is a top node of the resistor string 714.

The second buffer 712 may receive the middle reference driving voltage VDDREF_Mid from the first input node through a second voltage line VL2. A second input node of the second buffer 712 may be electrically connected to an output node of the second buffer 712. The second buffer 712 may supply the middle reference driving voltage VDDREF_Mid to a second node N2, which is a middle node of the resistor string 714.

The third buffer 713 may receive the bottom reference driving voltage VDDREF_Bot from the first input node through a third voltage line VL3. A second input node of the third buffer 713 may be electrically connected to an output node of the third buffer 713. The third buffer 713 may supply the bottom reference driving voltage VDDREF_Bot to a third node N3, which is the bottom node of the resistor string 714.

Since a relatively large voltage drop may occur in the driving voltage VDD of the middle area Mid of the display panel 110, the middle reference driving voltage VDDREF_Mid may be smaller than the top reference driving voltage VDDREF_Top and the bottom reference driving voltage VDDREF_Bot.

The resistor string 714 may include a plurality of resistors. A plurality of resistors may be connected in series from the first node N1, which is a top node, to the third node N3, which is a bottom node.

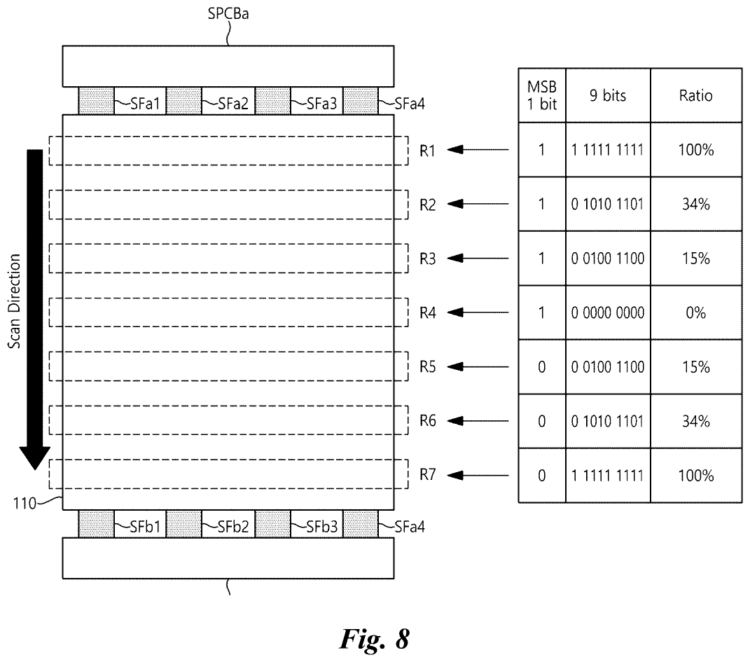

The resistor string 714 may receive the top reference driving voltage VDDREF_Top from the first node N1, which is the top node. The first node N1 may be referred to as the first node N1 shown in FIG. 8.

The resistor string 714 may receive the middle reference driving voltage VDDREF_Mid from the second node N2, which is the middle node. The second node N2 may be referred to as the second node N2 shown in FIG. 8.

The resistor string 714 may receive the bottom reference driving voltage VDDREF_Bot from the third node N3, which is the bottom node. The third node N3 may be referred to as the third node N3 shown in FIG. 8.

In each of the plurality of resistors disposed between the first node N1 of the resistor string 714 and the second node N2 of the resistor string 714, there may be formed divided voltages by dividing the top reference driving voltage VDDREF_Top and the middle reference driving voltage VDDREF_Mid according to voltage distribution.

In each of the plurality of resistors disposed between the third node N3 of the resistor string 714 and the second node N2 of the resistor string 714, there may be formed divided voltages by dividing the bottom reference driving voltage VDDREF_Bot and the middle reference driving voltage VDDREF_Mid according to voltage distribution.

The resistor string 714 may be electrically connected to a first multiplexer 715 through a plurality of upper connection lines. A plurality of upper connection lines may be electrically connected between the first node N1 and the second node N2.

The resistor string 714 may be electrically connected to a second multiplexer 716 through a plurality of lower connection lines. A plurality of lower connection lines may be electrically connected between the second node N2 and the third node N3. For convenience of explanation, if there are 100 upper connection lines and 100 lower connection lines, the upper connection lines may be expressed as the first to 100-th connection lines, and the lower connection lines may be expressed as the 101-st to 200-th connection lines. The number of upper and lower connection lines may change depending on the design of the first multiplexer 715 and the second multiplexer 716.

For example, the number of resistors may be 1023. In this case, each of the plurality of resistors may be electrically connected between adjacent connection lines. For example, a first resistor may be electrically connected between a first connection line CL1 and a second connection line CL2. The 1023-th resistor may be electrically connected between the 1023-th connection line CL1023 and the 1024-th connection line CL1024.

The feedback driving voltage generating circuit 710 may receive a 10-bits signal. The first multiplexer 715, the second multiplexer 716, and the third multiplexer 717 may be controlled based on a 10-bits signal. The most significant bit of the 10-bits signal may be supplied to the third multiplexer 717. The remaining 9-bits signal among the 10-bits signal may be supplied to the first multiplexer 715 and the second multiplexer 716. Depending on the most significant bit supplied to the third multiplexer 717, the first multiplexer 715 or the second multiplexer 716 may be selected.

For example, if the most significant bit is 1, the third multiplexer 717 may supply a first output voltage Vo1 to a third output line OL3. If the most significant bit is 0, the third multiplexer 717 may supply a second output voltage Vo2 to the third output line OL3.

The first multiplexer 715 may be electrically connected to the resistor string 714 through a plurality of upper connection lines. The first multiplexer 715 may select any one of the plurality of upper connection lines according to 9-bits signal, and may transfer the voltage supplied to the upper connection line to a first output line OL1. That is, the first multiplexer 715 may include a plurality of switches, and may supply the voltage of any one upper connection line to the first output line OL1 depending on whether the switch is controlled.

For example, the first multiplexer 715 may be a 9-bits multiplexer. The first multiplexer 715 may receive a 9-bits signal. Each bit of the 9-bits signal may have a value of 0 or 1. In this case, the number of upper connection lines may be 512, and the first multiplexer 715 may be electrically connected to 512 upper connection lines. The 512 upper connection lines may be expressed as a first connection line CL1 to a 512-th connection line CL512. The above-described 9-bits signal is an example, and may be designed to be larger or smaller than 9 bits.

For example, if the 9-bits signal for outputting the voltage of the first connection line CL1 adjacent to the first node N1 are supplied to the first multiplexer 715, the first multiplexer 715 may supply the voltage of the first connection line CL1 to the first output line OL1. In this case, the 9-bits signal may be 1 1111 1111. In this case, the most significant bit may be 1, and the 10-bits signal may be 11 1111 1111.

For example, the 9-bits signal for selecting the second connection line CL2 may be 1 1111 1110. In this case, the most significant bit may be 1, and the 10-bits signal may be 11 1111 1110.

For example, if the 9-bits signal for outputting the voltage of the 512-th connection line CL512 adjacent to the second node N2 are supplied to the first multiplexer 715, the first multiplexer 715 may supply the voltage of the 512-th connection line CL512 to the first output line OL1. In this case, the 9-bits signal may be 0 0000 0000. In addition, the most significant bit may be 1, and the 10-bits signal may be 10 0000 0000.

The second multiplexer 716 may be electrically connected to the resistor string 714 through a plurality of lower connection lines. The second multiplexer 716 may select one of the plurality of lower connection lines according to the bit signal, and supply the voltage supplied to the lower connection line to the second output line OL2. That is, the second multiplexer 716 may include a plurality of switches, and may supply the voltage of one lower connection line to the second output line OL2 depending on whether the switch is controlled.

For example, the second multiplexer 716 may be a 9-bit multiplexer. The second multiplexer 716 may receive 9-bits signal. Each bit of the 9-bits signal may have a value of 0 or 1. In this case, the number of lower connection lines may be 512, and the second multiplexer 716 may be electrically connected to 512 lower connection lines. The 512 lower connection lines may be expressed as the 513-th connection line CL513 to the 1024-th connection line CL1024. The above-described 9-bits signal is an example, and may be designed to be larger or smaller than 9 bits.

For example, if 9-bits signal for outputting the voltage of the first lower connection line adjacent to the second node N2 are supplied to the second multiplexer 716, the second multiplexer 716 may supply the voltage of the 513-th connection line CL513 to the second output line OL2. In this case, the 9-bits signal may be 0 0000 0000. In addition, the most significant bit may be 0, and the 10-bits signal may be 00 0000 0000.

For example, if 9-bits signal for outputting the voltage of the second lower connection line adjacent to the third node N3 are supplied to the second multiplexer 716, the second multiplexer 716 may supply the voltage of the 1024-th connection line CL1024 to the second output line OL2. In this case, 9-bits signal may be 1 1111 1111. In addition, the most significant bit may be 0, and the 10-bits signal may be 01 1111 1111.

The voltage output from the first multiplexer 715 may be a first output voltage Vo1, and the voltage output from the second multiplexer 716 may be second output voltage Vo2.

The third multiplexer 717 may be electrically connected to the first output line OL1 and the second output line OL2. The third multiplexer 717 may select one of the first output line OL1 and the second output line OL2 according to the most significant bit.

For example, the third multiplexer 717 may be a 1-bit multiplexer. The third multiplexer 717 may receive the most significant bit. The most significant bit may have a value of 0 or 1. If the most significant bit is 0, the third multiplexer 717 may supply the first output voltage Vo1 to the third output line OL3. If the most significant bit is 1, the third multiplexer 717 may supply the second output voltage Vo2 to the third output line OL3. The voltage supplied to the third output line OL3 may be referred to as a feedback driving voltage VDDFB.

The third multiplexer 717 may be electrically connected to the reference voltage conversion circuit 720 through the third output line OL3 to which the feedback driving voltage VDDFB is supplied.

The reference voltage conversion circuit 720 may generate a high reference voltage Vrg_H1 and a low reference voltage Vrg_L1 based on the feedback driving voltage VDDFB. The reference voltage conversion circuit 720 may supply the high reference voltage Vrg_H1 and the low reference voltage Vrg_L1 to the reference gamma voltage generating circuit 170.

The reference gamma voltage generating circuit 170 may be supplied with the high reference voltage Vrg_H1 generated based on the feedback driving voltage VDDFB and the low reference voltage Vrg_L1 generated based on the feedback driving voltage VDDFB, thereby compensating a reference gamma voltage Vrgm based on the voltage-dropped driving voltage VDD.

In addition, since the gamma voltage generating circuit 160 receives a reference gamma voltage Vrgm compensated based on the voltage-dropped driving voltage VDD, the gamma voltage generating circuit 160, the gamma voltage generating circuit 160 may supply a compensated gamma voltage Vgm compensated based on the voltage-dropped driving voltage VDD to the digital-to-analog conversion circuit 133.

Hereinafter, it will be described an example of operations of the gamma voltage compensation circuit 700, the reference gamma voltage generating circuit 170, and the gamma voltage generating circuit 160 with reference to FIG. 8.

FIG. 8 illustrates a scan signal supply direction and a 10-bits signal according to embodiments of the present disclosure.

Referring to FIG. 8, a source film SF may be electrically connected between the display panel 110 and a source printed circuit board SPCB. The source film SF may include top source films SFa1, SFa2, SFa3, and SFa4 electrically connected to the top source printed circuit board SPCBa. Additionally, the source film SF may include bottom source films SFb1, SFb2, SFb3, and SFb4 electrically connected to a bottom source printed circuit board SPCBb.

Referring to FIG. 8, there is illustrated a scan signal supply direction, that is, a scan direction. A scan signals may be sequentially supplied to the plurality of gate lines. The scan direction may be from the top to the bottom of the display panel.

For example, the positions of the display panel 110 be divided into a first row R1, a second row R2, a third row R3, a fourth row R4, a fifth row R5, a sixth row R6, and a seventh row R7. The first row R1 may be a row close to the top of the display panel 110, the seventh row R7 may be a row close to the bottom of the display panel 110, and the fourth row R4 may be a row corresponding to the center of a display panel 110. Referring to FIG. 8, the scan signal supply direction (i.e., scan direction) may proceed from the first row R1 to the seventh row R7.

Referring to FIG. 8, there is illustrated the most significant bit, the 9-bits signal, and relative bit ratio shown in a table. The relative bit ratio may refer to the ratio of the distance from the center of the display panel to the top (or bottom). Since the voltage drop of the driving voltage varies depending on the distance to the top (or bottom) of the display panel, the relative bit ratio may mean the compensation ratio of the driving voltage.

For example, when a scan signal is supplied to subpixels (not shown) arranged in the first row R1, the relative bit ratio may be 100%. In this case, the feedback driving voltage generating circuit 710 may receive a 10-bits signal of 11 1111 1111. The most significant bit is 1, and the remaining 9-bits may be 1 1111 1111. The binary number 1 1111 1111 corresponds to the decimal number 511, so the 100% means the ratio of 511/511. Referring to FIGS. 7 and 8, a feedback driving voltage VDDFB may be generated based on a 10-bits signal of 11 1111 1111, and a gamma voltage may be generated based on the feedback driving voltage VDDFB. The data driving circuit 130 may output a data voltage based on the gamma voltage to the data line.

For example, when a scan signal is supplied to subpixels (not shown) arranged in the second row R2, the relative bit ratio may be 34%. In this case, the feedback driving voltage generating circuit 710 may receive a 10-bits signal of 10 1010 1101. The most significant bit is 1, and the remaining 9-bits may be 0 1010 1101. The binary number 0 1010 1101 is the decimal number 173, so the 34% may mean the ratio of 173/511. Referring to FIGS. 7 and 8, a feedback driving voltage VDDFB may be generated based on a 10-bits signal of 10 1010 1101, and a gamma voltage may be generated based on the feedback driving voltage VDDFB. The data driving circuit 130 may output a data voltage based on the gamma voltage to the data line.

For example, when a scan signal is supplied to subpixels (not shown) arranged in the third row R3, the relative bit ratio may be 15%. In this case, the feedback driving voltage generating circuit 710 may receive a 10-bits signal of 10 0100 1100. The most significant bit is 1, and the remaining 9-bits may be 0 0100 1100. The binary number 0 0100 1100 is the decimal number 76, so the 15% means the ratio of 76/511. Referring to FIGS. 7 and 8, a feedback driving voltage VDDFB may be generated based on a 10-bits signal of 10 0100 1100, and a gamma voltage may be generated based on the feedback driving voltage VDDFB. The data driving circuit 130 may output a data voltage based on the gamma voltage to the data line.

For example, when a scan signal is supplied to subpixels (not shown) arranged in the fourth row R4, the relative bit ratio may be 0%. In this case, the feedback driving voltage generating circuit 710 may receive a 10-bits signal of 00 0000 0000. The most significant bit is 0, and the remaining 9-bits may be 0 0000 0000. The binary number 0 0000 0000 is the decimal number 0, so the 15% means the ratio of 0/511. Referring to FIGS. 7 and 8, a feedback driving voltage VDDFB may be generated based on a 10-bits signal of 00 0000 0000, and a gamma voltage may be generated based on the feedback driving voltage VDDFB. The data driving circuit 130 may output a data voltage based on the gamma voltage to the data line.

For example, when a scan signal is supplied to subpixels (not shown) arranged in the fifth row R5, the relative bit ratio may be 15%. In this case, the feedback driving voltage generating circuit 710 may receive a 10-bits signal of 00 0100 1100. The most significant bit is 0, and the remaining 9-bits may be 0 0100 1100. The binary number 0 0100 1100 is the decimal number 76, so the 15% means the ratio of 76/511. Referring to FIGS. 7 and 8, a feedback driving voltage VDDFB may be generated based on a 10-bits signal of 00 0100 1100, and a gamma voltage may be generated based on the feedback driving voltage VDDFB. The data driving circuit 130 may output a data voltage based on the gamma voltage to the data line.

For example, when a scan signal is supplied to subpixels (not shown) arranged in the sixth row R6, the relative bit ratio may be 34%. In this case, the feedback driving voltage generating circuit 710 may receive a 10-bits signal of 00 1010 1101. The most significant bit is 0, and the remaining 9-bits may be 0 1010 1101. The binary number 0 1010 1101 is the decimal number 173, so the 34% may mean the ratio of 173/511. Referring to FIGS. 7 and 8, a feedback driving voltage VDDFB may be generated based on a 10-bits signal of 00 1010 1101, and a gamma voltage may be generated based on the feedback driving voltage VDDFB. The data driving circuit 130 may output a data voltage based on the gamma voltage to the data line.

For example, when a scan signal is supplied to subpixels (not shown) arranged in the seventh row R7, the relative bit ratio may be 100%. In this case, the feedback driving voltage generating circuit 710 may receive a 10-bits signal of 01 1111 1111. The most significant bit is 0, and the remaining 9-bits may be 1 1111 1111. The binary number 1 1111 1111 corresponds to the decimal number 511, so the 100% means the ratio of 511/511. Referring to FIGS. 7 and 8, a feedback driving voltage VDDFB may be generated based on a 10-bits signal of 01 1111 1111, and a gamma voltage may be generated based on the feedback driving voltage VDDFB. The data driving circuit 130 may output a data voltage based on the gamma voltage to the data line.

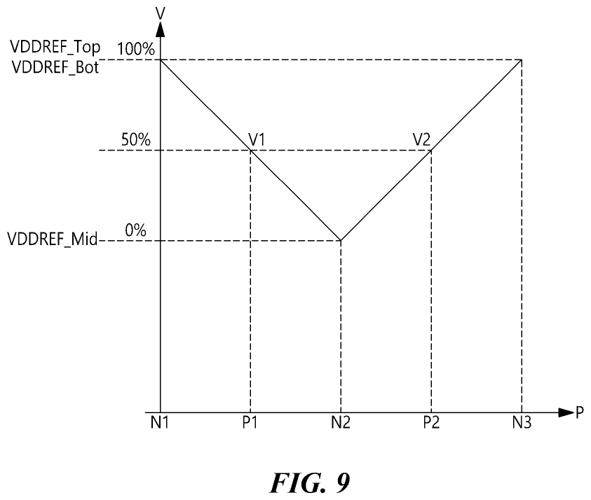

FIG. 9 illustrates a relative bit ratio according to a position of a display panel 110 according to embodiments of the present disclosure.

Referring to FIG. 9, there is illustrated a compensation ratio of the driving voltage according to the position of the display panel.

Referring to FIG. 9, the voltage of the first node N1 shown in FIG. 7 may be a top reference driving voltage VDDREF_Top. Since the voltage of the first node N1 corresponds to the driving voltage of the highest row of the display panel 110, the voltage of the first node N1 may correspond to the largest compensated feedback voltage. Therefore, the top reference driving voltage VDDREF_Top may correspond to a relative bit ratio of 100%.

The voltage of the third node N3 shown in FIG. 7 may be a bottom reference driving voltage VDDREF_Bot. Since the voltage of the third node N3 corresponds to the driving voltage of the lowest row of the display panel 110, the voltage of the third node N3 may correspond to a feedback voltage which is compensated the most. Therefore, the bottom reference driving voltage VDDREF_Bot may correspond to a relative bit ratio of 100%.

The voltage of the second node N2 shown in FIG. 7 may be a middle reference driving voltage VDDREF_Mid. Since the voltage of the second node N2 corresponds to the driving voltage of the row in the central portion of the display panel 110, the voltage of the second node N2 may correspond to the least compensated feedback voltage. Therefore, the middle reference driving voltage VDDREF_Mid may correspond to a relative bit ratio of 0%.

Referring to FIG. 9, the voltage corresponding to the middle position between the first node N1 and the second node N2 may correspond to a relative bit ratio of 50%.

Referring to FIG. 9, the voltage corresponding to the middle position between the second node N2 and the third node N3 may correspond to a relative bit ratio of 50%.

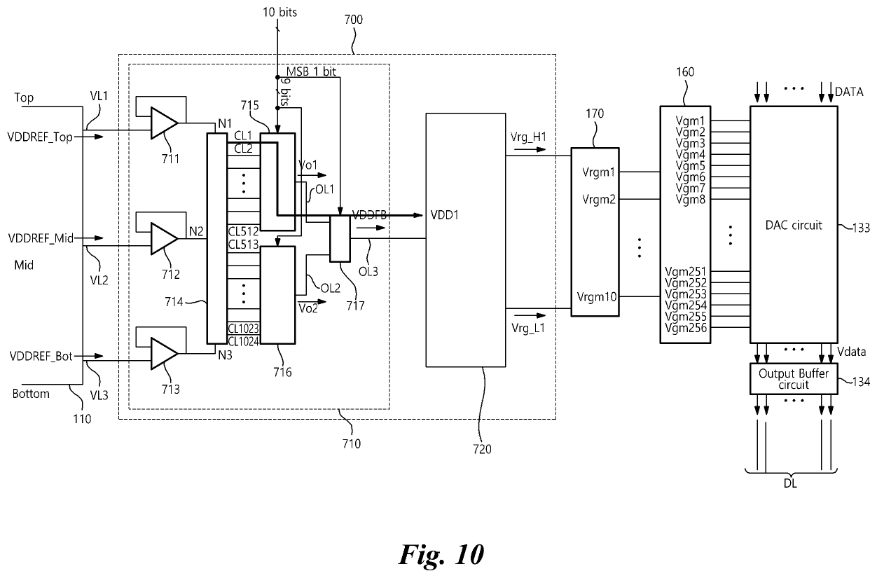

FIGS. 10 to 13 illustrate an example of an operation of a gamma voltage compensation circuit 700 according to embodiments of the present disclosure.

Referring to FIG. 10, the first multiplexer 715 may be electrically connected to the resistor string 714 through a plurality of upper connection lines, and the second multiplexer 716 may be electrically connected to the resistance string 714 through a plurality of lower connection lines.

Referring to FIG. 10, in order to compensate for the voltage drop of a first row driving voltage VDD1, the first multiplexer 715 may select a first connection line CL1 to supply the first row driving voltage VDD1 to the third multiplexer 717. In this case, the third multiplexer 717 may be controlled to receive the first row driving voltage VDD1, and the third multiplexer 717 may supply a feedback driving voltage VDDFB, which is the first row driving voltage VDD1, to the reference voltage conversion circuit 720. Thereafter, the reference voltage conversion circuit 720 may generate a high reference voltage Vrg_H1 and a low reference voltage Vrg_L1 based on the feedback driving voltage VDDFB. Since the feedback driving voltage VDDFB is the first row driving voltage VDD1, the high reference voltage Vrg_H1 and the low reference voltage Vrg_L1 may be generated based on the first row driving voltage VDD1. Therefore, the reference gamma voltage Vrgm and the gamma voltage Vgm generated based on the high reference voltage Vrg_H1 and the low reference voltage Vrg_L1 may be also generated based on the first row driving voltage VDD1. The gamma voltage Vgm generated based on the first row driving voltage VDD1 may be selected by the digital-to-analog converter DAC, and may be supplied to a plurality of subpixels electrically connected to a first gate line GL1.

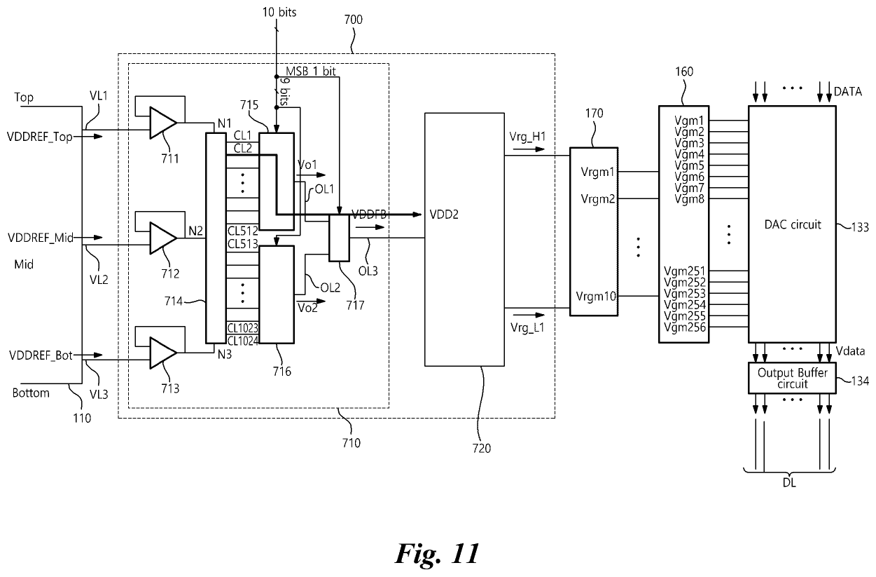

Referring to FIG. 11, in order to compensate for the voltage drop phenomenon of a second row driving voltage VDD2, the first multiplexer 715 may select a second connection line CL2 to supply the second row driving voltage VDD2 to the third multiplexer 717. In this case, the third multiplexer 717 may be controlled to receive the second row driving voltage VDD2, and the third multiplexer 717 may supply a feedback driving voltage VDDFB, which is the second row driving voltage VDD2, to the reference voltage conversion circuit 720. Thereafter, the reference voltage conversion circuit 720 may generate a high reference voltage Vrg_H1 and a low reference voltage Vrg_L1 based on the feedback driving voltage VDDFB. Since the feedback driving voltage VDDFB is the second row driving voltage VDD2, the high reference voltage Vrg_H1 and the low reference voltage Vrg_L1 may be generated based on the second row driving voltage VDD2. Therefore, the reference gamma voltage Vrgm and the gamma voltage Vgm generated based on the high reference voltage Vrg_H1 and the low reference voltage Vrg_L1 may be also generated based on the second row driving voltage VDD2. The gamma voltage Vgm generated based on the second row driving voltage VDD2 may be selected by the digital-to-analog converter DAC, and may be supplied to a plurality of subpixels electrically connected to a second gate line GL2.

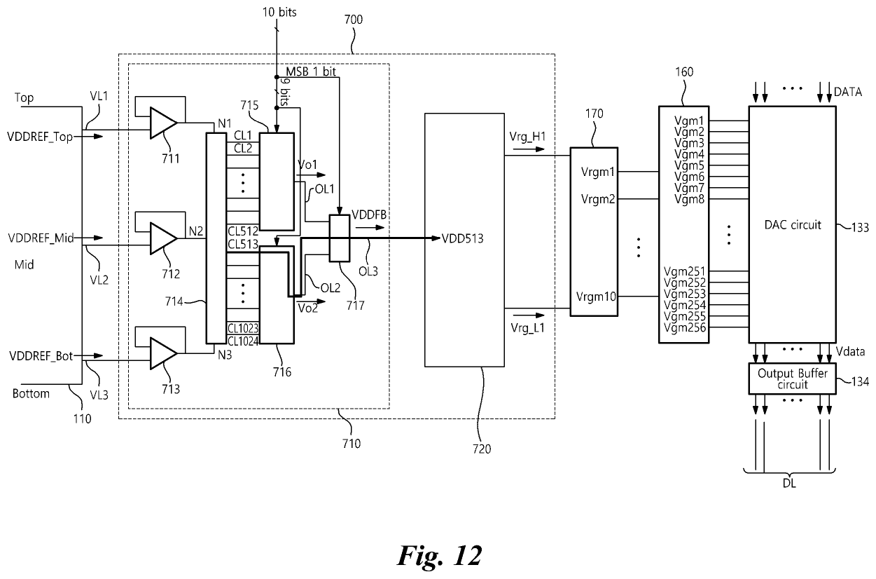

Referring to FIG. 12, in order to compensate for the voltage drop phenomenon of the driving voltage occurring in the 513-th gate line row, the second multiplexer 716 may select the 513-th connection line CL513 to supply the 513-th row driving voltage VDD513 to the third multiplexer 717. In this case, the third multiplexer 717 may be controlled to receive the 513-th row driving voltage VDD513, and the third multiplexer 717 may supply a feedback driving voltage VDDFB, which is the 513-th row driving voltage VDD513, to the reference voltage conversion circuit 720. Thereafter, the reference voltage conversion circuit 720 may generate a high reference voltage Vrg_H1 and a low reference voltage Vrg_L1 based on the feedback driving voltage VDDFB. Since the feedback driving voltage VDDFB is the 513-th row driving voltage VDD513, the high reference voltage Vrg_H1 and the low reference voltage Vrg_L1 may be generated based on the 513-th row driving voltage VDD513. Therefore, the reference gamma voltage Vrgm and the gamma voltage Vgm generated based on the high reference voltage Vrg_H1 and the low reference voltage Vrg_L1 may be also generated based on the 513-th row driving voltage VDD513. The gamma voltage Vgm generated based on the 513-th row driving voltage VDD513 may be selected by the digital-to-analog converter DAC, and may be supplied to a plurality of subpixels electrically connected to a 513-th gate line GL513.

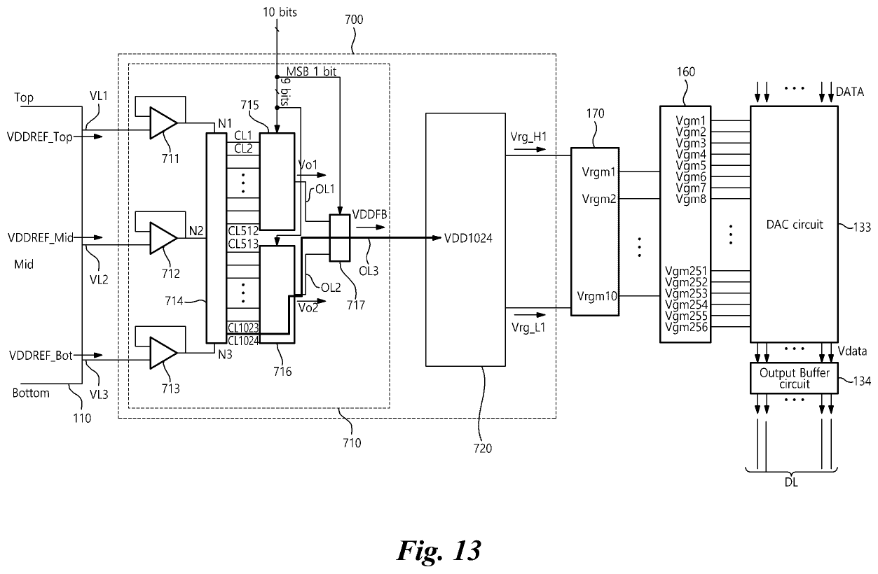

Referring to FIG. 13, in order to compensate for the voltage drop phenomenon of the driving voltage occurring in a 1024-th gate line row, the second multiplexer 716 may select the 1024-th connection line CL1024 to supply the 1024-th row driving voltage VDD1024 to the third multiplexer 717. In this case, the third multiplexer 717 may be controlled to receive the 1024-th row driving voltage VDD1024, and the third multiplexer 717 may supply a feedback driving voltage VDDFB, which is the 1024-th row driving voltage VDD1024, to the reference voltage conversion circuit 720. Thereafter, the reference voltage conversion circuit 720 may generate a high reference voltage Vrg_H1 and a low reference voltage Vrg_L1 based on the feedback driving voltage VDDFB. Since the feedback driving voltage VDDFB is the 1024-th row driving voltage VDD1024, the high reference voltage Vrg_H1 and the low reference voltage Vrg_L1 may be generated based on the 1024-th row driving voltage VDD1024. Therefore, the reference gamma voltage Vrgm and the gamma voltage Vgm generated based on the high reference voltage Vrg_H1 and the low reference voltage Vrg_L1 may be also generated based on the 1024-th row driving voltage VDD1024. The gamma voltage Vgm generated based on the 1024-th row driving voltage VDD1024 may be selected by the digital-to-analog converter DAC, and may be supplied to a plurality of subpixels electrically connected to a 1024-th gate line GL1024.

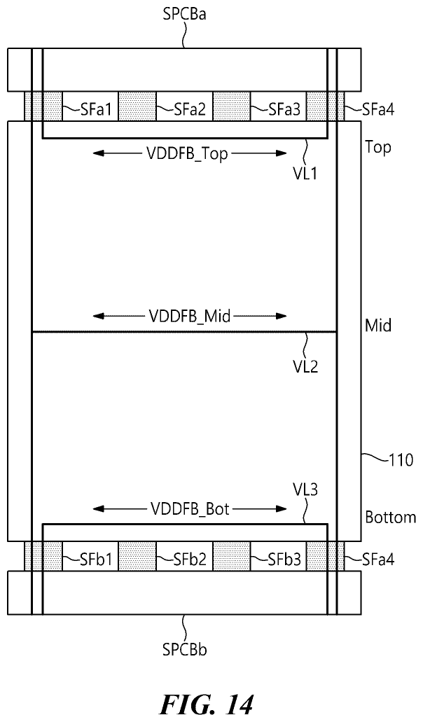

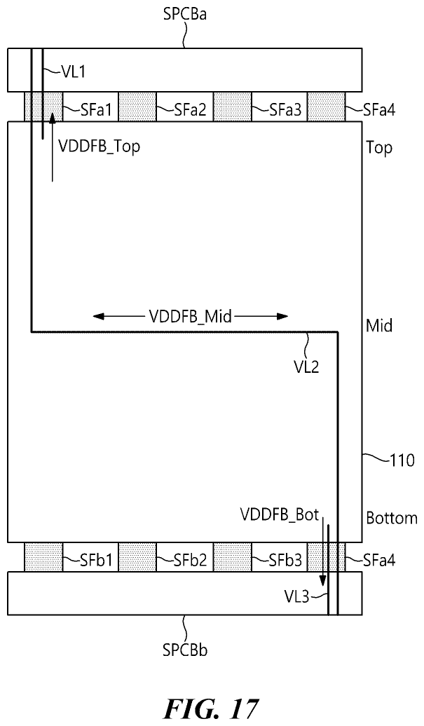

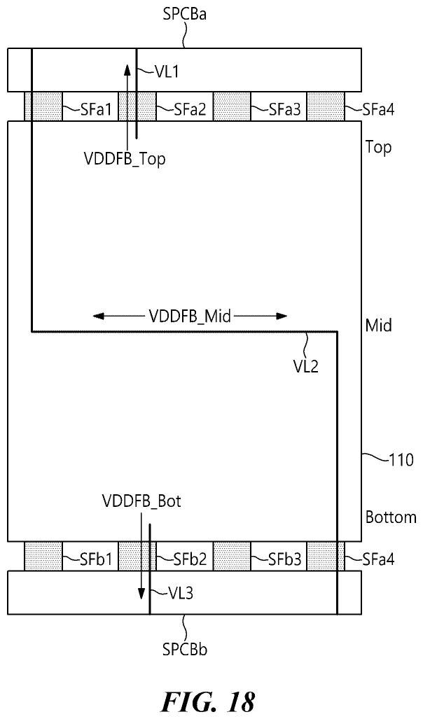

FIGS. 14 to 20 illustrate voltage lines VL disposed on a display panel 110 according to embodiments of the present disclosure.

Referring to FIGS. 14 to 19, a source film SF may be electrically connected between the display panel 110 and a source printed circuit board SPCB. The voltage line VL may be disposed on the display panel 110, the source film SF, and the source printed circuit board SPCB.

Referring to FIGS. 14 to 19, the source film SF may include top source films SFa1, SFa2, SFa3, and SFa4 electrically connected to a top source printed circuit board SPCBa. Additionally, the source film SF may include bottom source films SFb1, SFb2, SFb3, and SFb4 electrically connected to a bottom source printed circuit board SPCBb.

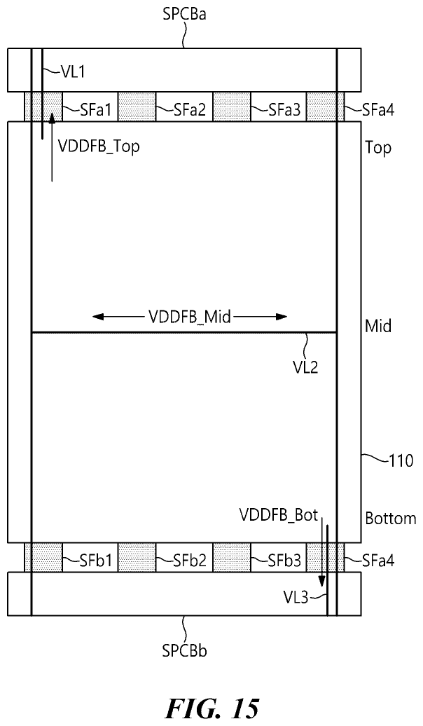

Referring to FIGS. 14, 16, and 19, a first voltage line VL1 may be disposed parallel to the top TOP of the display panel. The first voltage line VL1 may be disposed to pass through a first top source film SFa1 and a fourth top source film SFa4 from the display panel 110. The first voltage line VL1 may be disposed to pass from the first top source film SFa1 and the fourth top source film SFa4 to the top source printed circuit board SPCBa. However, referring to FIGS. 15, 17, and 18, the first voltage line VL1 may be disposed on only one side of the top TOP of the display panel and on the top source printed circuit board SPCBa. One side of the top TOP of the display panel may be any one of the left, right, and an area between the left and right sides of the display panel 110.

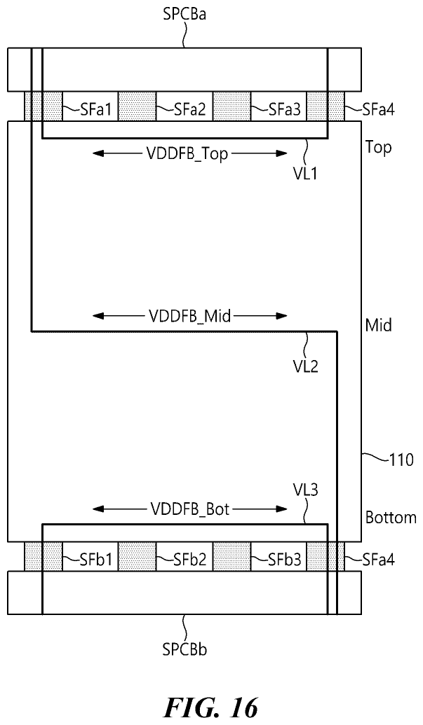

Referring to FIGS. 14, 16, and 19, the second voltage line VL2 may be disposed to be parallel to the middle Mid of the display panel. The second voltage line VL2 may be disposed to pass from the display panel 110 through the first top source film SFa1 and the fourth top source film SFa4. The second voltage line VL2 may be disposed to pass from the first top source film SFa1 and the fourth top source film SFa4 to the top source printed circuit board SPCBa. Additionally, the second voltage line VL2 may be disposed to pass from the display panel 110 through a first lower source film SFb1 and a fourth lower source film SFb4. The second voltage line VL2 may be disposed to pass from the first lower source film SFb1 and the fourth lower source film SFb4 to a lower source printed circuit board SPCBb. However, referring to FIGS. 16, 17, and 18, the second voltage line VL2 may be disposed to pass through one of the upper source films SFa1 and one of the lower source film SFb4.

Referring to FIGS. 14, 16, and 19, the third voltage line VL3 may be disposed parallel to the bottom of the display panel. The third voltage line VL3 may be disposed to pass from the display panel 110 through the first lower source film SFb1 and the fourth lower source film SFb4. The third voltage line VL3 may be disposed to pass from the first lower source film SFb1 and the fourth lower source film SFb4 to the lower source printed circuit board SPCBb. However, referring to FIGS. 15, 17, and 18, the third voltage line VL3 may be disposed on only one side of the bottom of the display panel and on the bottom source printed circuit board SPCBb. One side of the bottom of the display panel may be one of the left, right, and an area between the left and right sides of the display panel 110.

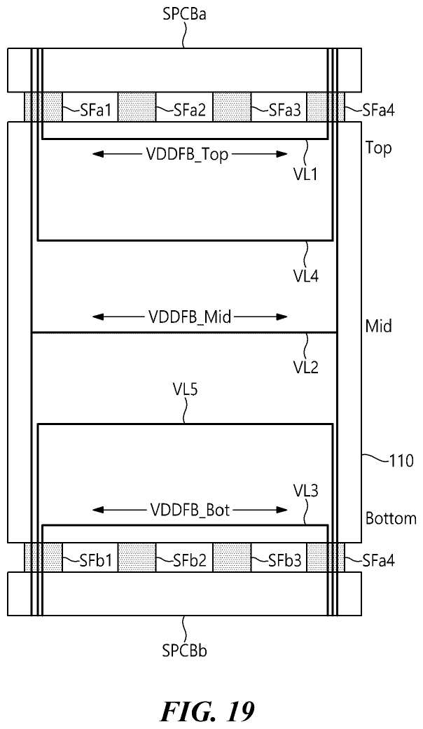

Referring to FIG. 19, the plurality of voltage lines VL may further include a fourth voltage line VL4 and a fifth voltage line VL5 in addition to the first to third voltage lines VL1 to VL3. The first to third voltage lines VL1 to VL3 shown in FIG. 19 may be the same as those shown in FIG. 14. Referring to FIG. 19, the fourth voltage line VL4 may be disposed to correspond to a row between the middle Mid and the top TOP of the display panel 110. The fourth voltage line VL4 may be disposed to pass from the display panel 110 through the first top source film SFa1 and the fourth top source film SFa4. The fourth voltage line VL4 may be disposed to pass from the first top source film SFa1 and the fourth top source film SFa4 to the top source printed circuit board SPCBa.

Referring to FIG. 19, the fifth voltage line VL5 may be disposed to correspond to a row between the mid and bottom of the display panel 110. The fifth voltage line VL5 may be disposed to pass from the display panel 110 through the first lower source film SFb1 and the fourth lower source film SFb4. The fifth voltage line VL5 may be disposed to pass from the first lower source film SFb1 and the fourth lower source film SFb4 to the lower source printed circuit board SPCBb.

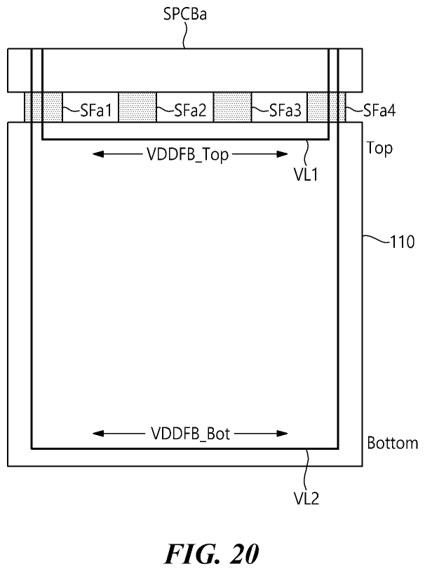

Meanwhile, referring to FIG. 20, the driving voltage VDD may be supplied to the display panel 110 in only one direction. The source films SFa1, SFa2, SFa3 and SFa4 may be electrically disposed between the display panel 110 and the top source printed circuit board SPCBa.

Referring to FIG. 20, the first voltage line VL1 may be disposed parallel to the top of the display panel. The first voltage line VL1 may be disposed to pass from the display panel 110 through the first top source film SFa1 and the fourth top source film SFa4. The first voltage line VL1 may be disposed to pass from the first top source film SFa1 and the fourth top source film SFa4 to the top source printed circuit board SPCBa.

Referring to FIG. 20, the second voltage line VL2 may be disposed parallel to the bottom of the display panel. The second voltage line VL2 may be disposed to pass from the display panel 110 through the first top source film SFa1 and the fourth top source film SFa4. The second voltage line VL2 may be disposed to pass from the first top source film SFa1 and the fourth top source film SFa4 to the top source printed circuit board SPCBa.

The driving voltage supply method shown in FIGS. 14 to 19 may be referred to as a “double feeding method,” and the driving voltage supply method shown in FIG. 20 may be referred to as a “single feeding method.”

Referring to FIG. 20, in the case of the single feeding method, the driving voltage VDD may be supplied from one side of the display panel 110, so that a voltage drop phenomenon of the driving voltage may occur the weakest at the top area Top of the display panel 110, and the voltage drop phenomenon of the driving voltage may occur most strongly at the bottom area of the display panel 110.

If the single feeding method is applied, the second multiplexer 716 and the lines electrically connected to the second multiplexer 716 may be excluded from the gamma voltage compensation circuit 700. If the double feeding method is applied, the voltage drop of the driving voltage may occur symmetrically on both sides, so that there may be designed that the first multiplexer 715 receives the driving voltage of one side as feedback and the second multiplexer 716 receives the driving voltage of the other side as feedback. In the case of the single feeding method, since the driving voltage VDD is supplied to only one side, the second multiplexer 716 and the lines electrically connected to the second multiplexer 716 may be excluded.

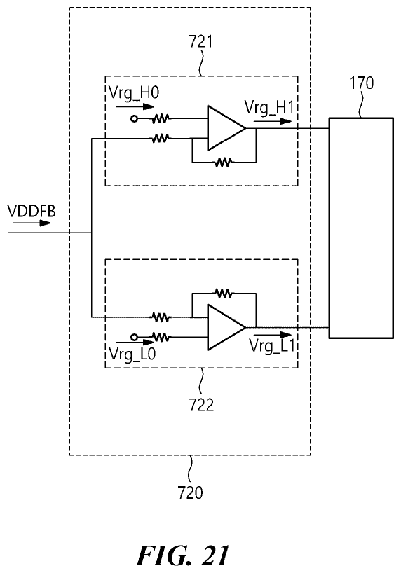

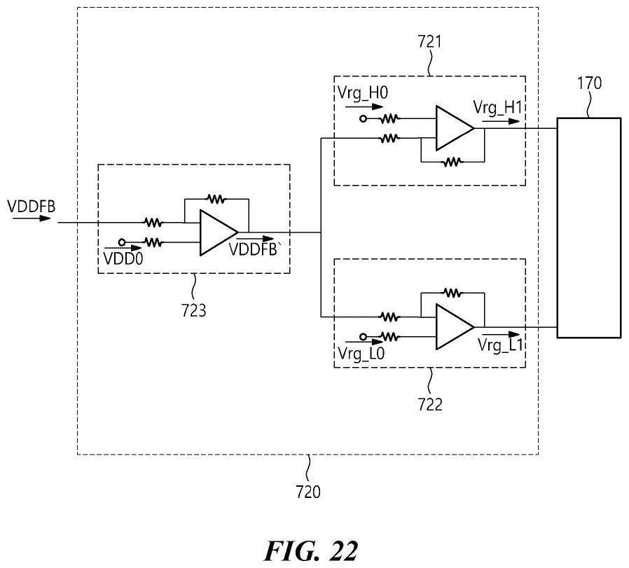

FIGS. 21 and 22 illustrate a reference voltage conversion circuit 720 according to embodiments of the present disclosure.

Referring to FIGS. 21 and 22, the reference voltage conversion circuit 720 may receive a feedback driving voltage VDDFB from the gamma voltage compensation circuit 700. The reference voltage conversion circuit 720 may generate a high reference voltage Vrg_H1 and a low reference voltage Vrg_L1 based on the feedback driving voltage VDDFB. The reference voltage conversion circuit 720 may supply the high reference voltage Vrg_H1 and the low reference voltage Vrg_L1 to the reference gamma voltage generating circuit 170.

Referring to FIG. 21, the reference voltage conversion circuit 720 may include a first comparator circuit 721 and a second comparator circuit 722.

Referring to FIG. 21, the first comparator circuit 721 may be configured as a comparator circuit capable of outputting a first comparison voltage Vrg_H1 based on the voltage supplied to two input terminals. The first comparator circuit 721 may receive a feedback driving voltage VDDFB through a first input terminal. The first comparator circuit 721 may receive an initial high reference voltage Vrg_H0 through a second input terminal. The first comparator circuit 721 may output a first comparison voltage Vrg_H1 based on the feedback driving voltage VDDFB and the initial high reference voltage Vrg_H0. The first comparison voltage Vrg_H1 may be the high reference voltage Vrg_H1. The relationship between the feedback driving voltage VDDFB, the initial high reference voltage Vrg_H0, and the high reference voltage Vrg_H1 may be “Vrg_H1=2*(½*Vrg_H0+½*VDDFB).”

Referring to FIG. 21, the second comparator circuit 722 may be configured as a comparator circuit capable of outputting a second comparison voltage Vrg_L1 based on the voltage supplied to two input terminals. The second comparator circuit 722 may receive a feedback driving voltage VDDFB through a first input terminal. The second comparator circuit 722 may receive an initial low reference voltage Vrg_L0 through a second input terminal. The second comparator circuit 722 may output a second comparison voltage Vrg_L1 based on the feedback driving voltage VDDFB and the initial low reference voltage Vrg_L0. The second comparison voltage Vrg_L1 may be the low reference voltage Vrg_L1. The relationship between the feedback driving voltage VDDFB, the initial low reference voltage Vrg_L0, and the low reference voltage Vrg_L1 may be “Vrg_L1=2*(½*Vrg_L0+½*VDDFB).”

Referring to FIG. 22, the reference voltage conversion circuit 720 may further include a third comparator circuit 723 in addition to the first and second comparator circuits 721 and 722.

Referring to FIG. 22, the third comparator circuit 723 may be configured as a comparator circuit capable of outputting a third comparison voltage VDDFB′ based on the voltage supplied to two input terminals. The third comparator circuit 723 may receive a feedback driving voltage VDDFB through a first input terminal. The third comparator circuit 723 may receive an initial driving voltage VDD0 without the voltage drop through a second input terminal. The third comparator circuit 723 may output a third comparison voltage VDDFB′ based on the feedback driving voltage VDDFB and the initial driving voltage VDD0. The relationship between the feedback driving voltage VDDFB, the initial driving voltage VDD0, and the third comparison voltage VDDFB′ may be “VDDFB′=VDD0−VDDFB.”

Referring to FIG. 22, the third comparison voltage VDDFB′ may be supplied to the first input terminal of the first comparator circuit 721 and the first input terminal of the second comparator circuit 722. The operation of the first comparator circuit 721 and the second comparator circuit 722 shown in FIG. 21 may be the same as the first comparator circuit 721 and the second comparator circuit 722 shown in FIG. 20. In this case, the relational expression of the high reference voltage Vrg_H1 output from the first comparator circuit 721 may be “Vrg_H1=Vrg_H0−(VDD0−VDDFB),” and the relational expression of the low reference voltage Vrg_L1 output from the second comparator circuit 722 may be “Vrg_L1=Vrg_L0−(VDD0−VDDFB).”

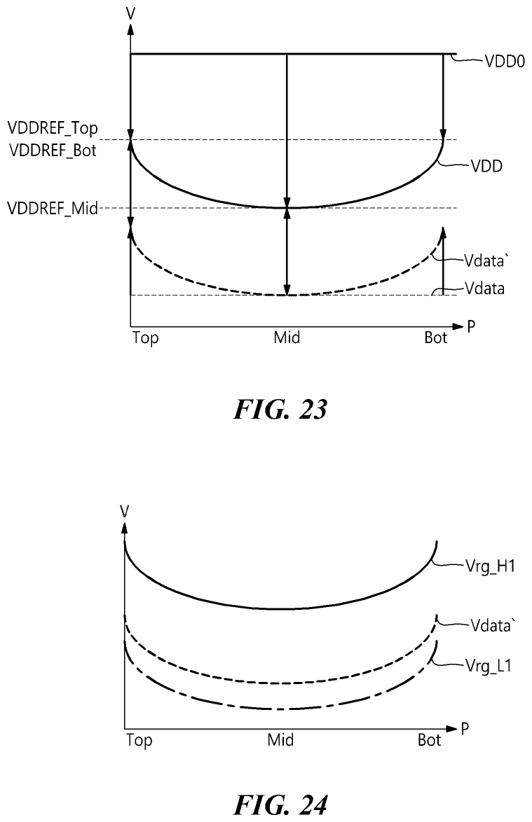

FIGS. 23 and 24 are graphs of voltage according to an operation of a feedback driving voltage generating circuit 710 and the reference voltage conversion circuit 720 according to embodiments of the present disclosure.

Referring to FIG. 23, a power management circuit 150 may output initial driving voltages VDD0 having the same voltage level to the display panel 110. A voltage drop may occur in the initial driving voltage VDD0, and the degree of the voltage drop may vary depending on the position in the display panel 110. A weak voltage drop may occur in the top and bottom areas, and the strongest voltage drop may occur in the middle area.

Referring to FIG. 23, a voltage drop may occur in the driving voltage VDD depending on the position, so that the distribution of the driving voltage VDD depending on the position may be in a “U” shape. After a voltage drop occurs in the driving voltage VDD depending on the position, the feedback driving voltage generating circuit 710 may operate to supply the feedback driving voltage VDDFB to the reference voltage conversion circuit 720. The reference voltage conversion circuit 720 may generate a high reference voltage Vrg_H1 and a low reference voltage Vrg_L1 based on the feedback driving voltage VDDFB.

Referring to FIG. 24, since the feedback driving voltage VDDFB reflects the driving voltage VDD with a “U”-shaped voltage drop, the voltage distribution of the high reference voltage Vrg_H1 and the low reference voltage Vrg_L1 may represent a “U” shape.

Thereafter, the reference voltage conversion circuit 720 may supply the high reference voltage Vrg_H1 and the low reference voltage Vrg_L1 to the reference gamma voltage generating circuit 170.

The reference gamma voltage generating circuit 170 may be supplied with a high reference voltage Vrg_H1 generated based on the feedback driving voltage VDDFB and a low reference voltage Vrg_L1 generated based on the feedback driving voltage VDDFB, so that the reference gamma voltage Vrgm may be compensated based on the voltage-dropped driving voltage VDD.

In addition, since the gamma voltage generating circuit 160 receives a reference gamma voltage Vrgm compensated based on the voltage-dropped driving voltage VDD, the gamma voltage generating circuit 160 may supply a compensated gamma voltage Vgm compensated based on the voltage-dropped driving voltage VDD to the digital-to-analog conversion circuit 133.

Referring to FIGS. 23 and 24, since the gamma voltage Vgm is generated based on the high reference voltage Vrg_H1 and the low reference voltage Vrg_L1 formed in the “U-shaped” voltage distribution, the voltage distribution of the data voltage Vdata may also represent a “U” shape.

According to embodiments of the present disclosure, it is possible to compensate the voltage drop phenomenon of the driving voltage VDD.

According to embodiments of the present disclosure, it is possible to equalize the luminance of the display panel 110.

According to embodiments of the present disclosure, it is possible to implement the low power consumption by equalizing the luminance of the display panel 110.

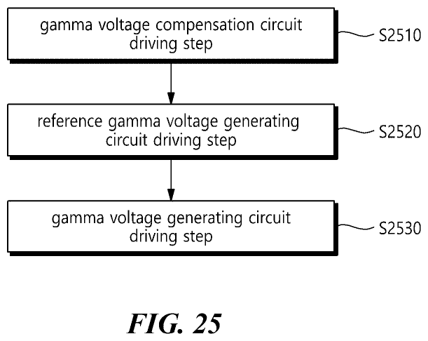

FIG. 25 is a flowchart of a driving method of a display device according to embodiments of the present disclosure.

A driving method of a display device according to embodiments of the present disclosure may include a gamma voltage compensation circuit driving step (S2510), a reference gamma generating circuit driving step (S2520), and a gamma voltage generating circuit driving step (S2520).

In a first step which is the gamma voltage compensation circuit driving step (S2510), the gamma voltage compensation circuit 700 may supply a high reference voltage Vrg_H1 and a low reference voltage Vrg_L1 to the reference gamma voltage generating circuit 170.

The second step, which is the reference gamma generating circuit driving step (S2520), may a step of generating and supplying a plurality of reference gamma voltages Vrgm based on the high reference voltage Vrg_H1 and the low reference voltage Vrg_L1 to the gamma voltage generating circuit 160.

The third step, which is the gamma voltage generating circuit driving step (S2520), may be a step of supplying a plurality of gamma voltages Vgm to the data driving circuit 130 based on a plurality of reference gamma voltages Vrgm. The gamma voltage compensation circuit 700 may be electrically connected to the display panel through a first voltage line and a second voltage line.

Embodiments of the present disclosure described above are briefly described as follows.

Embodiments of the present disclosure may provide a display device including a data driving circuit configured to be supplied with a plurality of gamma voltages, a gamma voltage generating circuit configured to supply the plurality of gamma voltages to the data driving circuit, a reference gamma voltage generating circuit configured to generate a plurality of reference gamma voltages based on a high reference voltage and a low reference voltage and supply the plurality of reference gamma voltages to the gamma voltage generating circuit, and a gamma voltage compensation circuit configured to supply the high reference voltage and the low reference voltage to the reference gamma generating circuit, wherein the gamma voltage compensation circuit is electrically connected to a display panel through a first voltage line and a second voltage line.

The gamma voltage compensation circuit may be supplied with a first reference driving voltage through the first voltage line and a second reference driving voltage through the second voltage line.

The gamma voltage compensation circuit may include a feedback driving voltage generating circuit configured to generate a feedback driving voltage based on the first reference driving voltage and the second reference driving voltage, and a reference voltage conversion circuit configured to generate the high reference voltage and the low reference voltage based on the feedback driving voltage.

The feedback driving voltage generating circuit may include a first buffer electrically connected to the first voltage line, a second buffer electrically connected to the second voltage line, a resistor string electrically connected to the first buffer and a first node and electrically connected to the second buffer and a second node, and a multiplexer electrically connected to the resistor string through a plurality of connection lines.

A plurality of gate lines may be disposed on the display panel. When a turn-on scan signal is supplied to the first gate line, the multiplexer may select a first connection line.

A voltage supplied to the multiplexer through the first connection line may correspond to a driving voltage supplied to a subpixel electrically connected to the first gate line.

The multiplexer may include a plurality of switches, and the multiplexer may control the plurality of switches to select one of the plurality of connection lines.

The first voltage line may be electrically connected to a first area of the display panel, and the second voltage line may be electrically connected to a second area of the display panel. The driving voltage in the second area may be smaller than the driving voltage in the first area.

The first voltage line may be disposed parallel to a gate line disposed in the first area, and the second voltage line may be disposed parallel to a gate line disposed in the second area.

A third voltage line may be electrically connected to a third area of the display panel. The first voltage line may be electrically connected to the gamma voltage compensation circuit through an upper source printed circuit board, and the third voltage line may be electrically connected to the gamma voltage compensation circuit through a lower source printed circuit board.

The reference voltage conversion circuit may include a first comparator circuit configured to output the high reference voltage based on the feedback driving voltage and an initial high reference voltage, and a second comparator circuit configured to output the low reference voltage based on the feedback driving voltage and an initial low reference voltage.

The reference voltage conversion circuit may include a first comparator circuit configured to output the high reference voltage based on a first input voltage and an initial high reference voltage, a second comparator circuit configured to output the low reference voltage based on the first input voltage and the initial low reference voltage, and a third comparator circuit configured to output the first input voltage based on the feedback driving voltage and an initial driving voltage.

The display panel may include a plurality of gate lines. A first high reference voltage when a turn-on scan signal is supplied to a first gate line may be greater than a second high reference voltage when the turn-on scan signal is supplied to a second gate line. In addition, a first low reference voltage when a turn-on scan signal is supplied to the first gate line may be greater than a second low reference voltage when the turn-on scan signal is supplied to the second gate line.

The data driving circuit may select and output a gamma voltage corresponding to image data among the plurality of gamma voltages.

Embodiments of the present disclosure may provide a driving method of a display device including supplying, by a gamma voltage compensation circuit, a high reference voltage and a low reference voltage to a reference gamma voltage generating circuit, generating and supplying a plurality of reference gamma voltages based on the high reference voltage and the low reference voltage to a gamma voltage generating circuit, and supplying a plurality of gamma voltages to a data driving circuit based on the plurality of reference gamma voltages, wherein the gamma voltage compensation circuit is electrically connected to a display panel through a first voltage line and a second voltage line.

In the supplying a high reference voltage and a low reference voltage, the gamma voltage compensation circuit may be supplied with a first reference driving voltage through the first voltage line and a second reference driving voltage through the second voltage line.

The gamma voltage compensation circuit may include a feedback driving voltage generating circuit configured to generate a feedback driving voltage based on the first reference driving voltage and the second reference driving voltage, and a reference voltage conversion circuit configured to generate the high reference voltage and the low reference voltage based on the feedback driving voltage.

The feedback driving voltage generating circuit may include a first buffer electrically connected to the first voltage line, a second buffer electrically connected to the second voltage line, a resistor string electrically connected to the first buffer and a first node and electrically connected to the second buffer and a second node, and a multiplexer electrically connected to the resistor string through a plurality of connection lines.

A plurality of gate lines may be disposed on the display panel. When a turn-on scan signal is supplied to the first gate line, the multiplexer may select a first connection line.

The first voltage line may be electrically connected to a first area of the display panel, and the second voltage line may be electrically connected to a second area of the display panel. In addition, the driving voltage in the second area may be smaller than the driving voltage in the first area.

Embodiments of the present disclosure may provide a driving method of a display device, including: supplying a first reference driving voltage through a first voltage line and a second reference driving voltage through a second voltage line from a display panel of the display device; generating a feedback driving voltage based on the first reference driving voltage and the second reference driving voltage; generating a high reference voltage and a low reference voltage based on the feedback driving voltage; generating a plurality of reference gamma voltages based on the high reference voltage and the low reference voltage; generating a plurality of gamma voltages based on the plurality of reference gamma voltages; and selecting and supplying a gamma voltage corresponding to image data among the plurality of gamma voltages to the display panel.

The first voltage line may be electrically connected to a first area of the display panel, and the second voltage line may be electrically connected to a second area of the display panel. In addition, a driving voltage in the second area may be smaller than a driving voltage in the first area.

The above description and the accompanying drawings provide an example of the technical idea of the present disclosure for illustrative purposes only. Various modifications, additions and substitutions to the described embodiments will be readily apparent to those skilled in the art without departing from the spirit and scope of the present disclosure. In addition, the disclosed embodiments are intended to illustrate the scope of the technical idea of the present disclosure. Thus, the scope of the present disclosure is not limited to the embodiments shown.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display device comprising:
a data driving circuit configured to be supplied with a plurality of gamma voltages;
a gamma voltage generating circuit configured to supply the plurality of gamma voltages to the data driving circuit;
a reference gamma voltage generating circuit configured to generate a plurality of reference gamma voltages based on a high reference voltage and a low reference voltage and supply the plurality of reference gamma voltages to the gamma voltage generating circuit; and
a gamma voltage compensation circuit configured to supply the high reference voltage and the low reference voltage to the reference gamma voltage generating circuit,
wherein the gamma voltage compensation circuit is electrically connected to a display panel through a first voltage line and a second voltage line.

2. The display device of claim 1, wherein the gamma voltage compensation circuit is supplied with a first reference driving voltage through the first voltage line and a second reference driving voltage through the second voltage line.

3. The display device of claim 2, wherein the gamma voltage compensation circuit comprises:
a feedback driving voltage generating circuit configured to generate a feedback driving voltage based on the first reference driving voltage and the second reference driving voltage; and
a reference voltage conversion circuit configured to generate the high reference voltage and the low reference voltage based on the feedback driving voltage.

4. The display device of claim 3, wherein the feedback driving voltage generating circuit comprises:
a first buffer electrically connected to the first voltage line;
a second buffer electrically connected to the second voltage line;
a resistor string electrically connected to the first buffer and a first node and electrically connected to the second buffer and a second node; and
a multiplexer electrically connected to the resistor string through a plurality of connection lines.

5. The display device of claim 4, wherein a plurality of gate lines are disposed on the display panel,
wherein, when a turn-on scan signal is supplied to a first gate line, the multiplexer selects a first connection line.

6. The display device of claim 5, wherein a voltage supplied to the multiplexer through the first connection line corresponds to a driving voltage supplied to a subpixel electrically connected to the first gate line.

7. The display device of claim 4, wherein the multiplexer includes a plurality of switches,
wherein the multiplexer controls the plurality of switches to select one of the plurality of connection lines.

8. The display device of claim 1, wherein the first voltage line is electrically connected to a first area of the display panel, and the second voltage line is electrically connected to a second area of the display panel,
wherein a driving voltage in the second area is smaller than a driving voltage in the first area.

9. The display device of claim 8, wherein the first voltage line is disposed parallel to a gate line disposed in the first area, and the second voltage line is disposed parallel to a gate line disposed in the second area.

10. The display device of claim 8, wherein a third voltage line is electrically connected to a third area of the display panel,
wherein the first voltage line is electrically connected to the gamma voltage compensation circuit through an upper source printed circuit board,
wherein the third voltage line is electrically connected to the gamma voltage compensation circuit through a lower source printed circuit board.

11. The display device of claim 3, wherein the reference voltage conversion circuit comprises:
a first comparator circuit configured to output the high reference voltage based on the feedback driving voltage and an initial high reference voltage; and
a second comparator circuit configured to output the low reference voltage based on the feedback driving voltage and an initial low reference voltage.

12. The display device of claim 3, wherein the reference voltage conversion circuit comprises:
a first comparator circuit configured to output the high reference voltage based on a first input voltage and an initial high reference voltage;
a second comparator circuit configured to output the low reference voltage based on the first input voltage and an initial low reference voltage; and
a third comparator circuit configured to output the first input voltage based on the feedback driving voltage and an initial driving voltage.

13. The display device of claim 3, wherein the display panel includes a plurality of gate lines,
wherein a first high reference voltage when a turn-on scan signal is supplied to a first gate line is greater than a second high reference voltage when the turn-on scan signal is supplied to a second gate line,
wherein a first low reference voltage when a turn-on scan signal is supplied to the first gate line is greater than a second low reference voltage when the turn-on scan signal is supplied to the second gate line.

14. The display device of claim 1, wherein the data driving circuit selects and outputs a gamma voltage corresponding to image data among the plurality of gamma voltages.

15. A driving method of a display device comprising:
supplying, by a gamma voltage compensation circuit, a high reference voltage and a low reference voltage to a reference gamma voltage generating circuit;
generating and supplying a plurality of reference gamma voltages based on the high reference voltage and the low reference voltage to a gamma voltage generating circuit; and
supplying a plurality of gamma voltages to a data driving circuit based on the plurality of reference gamma voltages,
wherein the gamma voltage compensation circuit is electrically connected to a display panel through a first voltage line and a second voltage line.

16. The driving method of claim 15, wherein, in the supplying a high reference voltage and a low reference voltage, the gamma voltage compensation circuit is supplied with a first reference driving voltage through the first voltage line and a second reference driving voltage through the second voltage line.

17. The driving method of claim 16, wherein the gamma voltage compensation circuit comprises:
a feedback driving voltage generating circuit configured to generate a feedback driving voltage based on the first reference driving voltage and the second reference driving voltage; and
a reference voltage conversion circuit configured to generate the high reference voltage and the low reference voltage based on the feedback driving voltage.

18. The driving method of claim 17, wherein the feedback driving voltage generating circuit comprises:
a first buffer electrically connected to the first voltage line;
a second buffer electrically connected to the second voltage line;
a resistor string electrically connected to the first buffer and a first node and electrically connected to the second buffer and a second node; and
a multiplexer electrically connected to the resistor string through a plurality of connection lines.

19. The driving method of claim 18, wherein a plurality of gate lines are disposed on the display panel,
wherein, when a turn-on scan signal is supplied to a first gate line, the multiplexer selects a first connection line.

20. The driving method of claim 15, wherein the first voltage line is electrically connected to a first area of the display panel, and the second voltage line is electrically connected to a second area of the display panel,
wherein a driving voltage in the second area is smaller than a driving voltage in the first area.
